(19) United States
(12) Patent Application Publication
(10) Pub. No.: US 2023/0348263 A1
(43) Pub. Date: Nov. 2, 2023

(54) LIQUID FORMULATION FOR HYDROGEN STORAGE

(71) Applicant: ARKEMA FRANCE, COLOMBES (FR)

(72) Inventor: Jérôme BLANC, PIERRE-BENITE Cedex (FR)

(21) Appl. No.: 17/999,115

(22) PCT Filed: Dec. 7, 2021
(86) PCT No.: PCT/FR2021/052222

§ 371 Date: Nov. 17, 2022

(30) Foreign Application Priority Data
Dec. 9, 2020 (FR) FR2012922

(51) Int. Cl. C01B 3/00

(52) U.S. Cl. CPC C01B 3/0015

(57) ABSTRACT

The present invention relates to a liquid formulation comprising an amount greater than or equal to 50 wt % benzyltoluene and an amount of less than 0.5 mol % diphenylmethane. The invention also relates to the use of said formulation as LOHC for the production of hydrogen comprising less than 0.5 mol % diphenylmethane.

The present invention relates to the field of liquid formulations capable of transporting hydrogen, and more particularly the field of benzyltoluene-based formulations capable of transporting hydrogen.

Hydrogen today represents one alternative to the fossil, natural or electrical energy sources. Storing and transporting this hydrogen energy source, however, remains a major challenge for the rapid and accessible development of this energy source.

Various approaches to the easier storage and transportation of this very volatile and highly explosive gas have been studied, including pressurized storage, cryogenic storage, and storage on supports. The types of support that may be contemplated include the technology based on liquid organic hydrogen carriers (LOHCs), which is a promising technology of particular interest for long-distance transport with costs entirely compatible with a large-scale development.

The principle of this LOHC technology consists in fixing hydrogen on a support molecule, which is preferably and most often liquid at ambient temperature, in a hydrogenation step, then in releasing the fixed hydrogen, close to the site of consumption, in a dehydrogenation step.

Among the LOHC molecules studied today, aromatic liquids with two or three rings, such as, for example, benzyltoluene (BT) and/or dibenzyltoluene (DBT) which have already been the subject of numerous studies and patent applications, represent molecules particularly well suited to this use. Patent EP 2 925 669 thus demonstrates the use of BT and/or DBT in LOHC technology, and describes the hydrogenation and dehydrogenation operations of these fluids for hydrogen storage and release.

Beyond the instantaneous performance quality of the hydrogenation and dehydrogenation steps, the sequence of the cycles and the maintenance of the performance qualities (hydrogen fixation/release yield) and also the purity of the hydrogen extracted (or released) during the dehydrogenation step are key points for the economic aspect of this technology.

This is because the hydrogen resulting from this LOHC technology finds uses in a great many fields, such as, for example, in fuel cells, and in diverse industrial processes, or else as fuel for all means of transport, such as trains, boats, trucks, automobiles, aircraft, etc. Any impurity present in the hydrogen, even in trace amounts, could have a negative impact both on the hydrogenation/dehydrogenation process in terms of yield, and on the quality of the products manufactured or else on the yields in the end uses of the hydrogen produced by this technique.

To overcome these potential problems, one of the solutions is for the hydrogen released during the dehydrogenation step to be as pure as possible. However, the hydrogen released during the dehydrogenation step inevitably entrains with it impurities resulting from organic compounds often present in the organic liquid to be dehydrogenated.

These impurities are of various kinds, and may be present in greater or lesser amounts, not only in the original LOHC fluid but also in the LOHC fluid after it has undergone numerous hydrogenation/dehydrogenation cycles (called “LOHC fluid” in the remainder of the present specification).

Among the LOHC fluids most widely studied at present and offering the greatest promise, benzyltoluene (BT) is a compound of choice, particularly due to its physicochemical properties entirely compatible with operations of hydrogenation/dehydrogenation and to the existing industrial preparation capacities. BT, indeed, is a well-known, commercially available compound whose method of preparation is likewise well-known to those skilled in the art. For example, BT is readily preparable by catalytic reaction of toluene with chlorotoluene, by techniques now well-known to those skilled in the art, and particularly as described in patent EP0435737.

However, particularly because of the presence of traces of benzene in the initial toluene, the synthesis of BT may lead to the formation of a by-product, diphenylmethane (DPM), resulting from coupling between the benzene and the chlorotoluene. It is also possible for diphenylmethane to be formed, undesirably, during the BT hydrogenation/dehydrogenation cycles.

So the crude BT synthesis products, but also the BT-based LOHC fluids that have been engaged in hydrogenation/dehydrogenation cycles, may therefore contain—in variable amounts—diphenylmethane, which can prove to be disruptive if present in too great an amount in an LOHC fluid, such as BT.

Consequently there remains a need for LOHC fluids that perform, from the standpoints both of yield in storage terms (hydrogenation/dehydrogenation cycles) and of the purity of the hydrogen released during the dehydrogenation step. Still further objectives will become apparent in the continuation of the description of the invention, which is set out in more detail below.

The Applicant has now found an LOHC fluid formulation entirely suitable for the storage and transport of hydrogen that is capable of releasing high-purity hydrogen during the dehydrogenation step.

In a first aspect, therefore, the present invention relates to a liquid formulation based on benzyltoluene (BT) containing low amounts of diphenylmethane (DPM). This type of formulation particularly enables the overcoming of some or all of the drawbacks raised in the prior art for LOHC liquids, meeting in particular the requirements of storage, transport and extraction of hydrogen, under optimal industrial and economic conditions, and enabling the release, during the step of dehydrogenation of said formulation, of high-purity hydrogen, and particularly of hydrogen having very low levels of undesirable products, particularly of DPM and its potential degradation products, such as benzene, the latter being particularly detrimental for the uses of hydrogen in fuel cells, for example.

Diphenylmethane, moreover, has a melting point (25° C.) much higher than that of benzyltoluene (−80° C.), but also of another LOHC fluid, dibenzyltoluene (−38.5° C.). Consequently, the DPM may form a turbidity or may even precipitate, when present in excessive amounts in the BT, and this may prove disruptive or even prohibitive, particularly during operations of transport and transfer of the LOHC fluid through pipelines, pumps, valves and other equipment necessary to the use of said LOHC fluid contemplated in the present invention, and particularly during transport and during use in hydrogenation/dehydrogenation cycles.

Furthermore, the presence of DPM in a benzyltoluene-base liquid formulation results primarily from the presence of benzene in the raw materials employed during the synthesis of BT and holds out the potential risk of traces of benzene in the end product, in which event this benzene might contaminate the hydrogen released during the dehydrogenation step.

Similarly, the inevitable degradation of DPM at high temperature and in contact with the catalysts employed during the hydrogenation/dehydrogenation cycles may lead to the formation of significant amounts of benzene, in which event this benzene might contaminate the hydrogen released during the dehydrogenation step.

More specifically, the present invention relates to a liquid formulation comprising:
an amount of not less than 50%, preferably not less than 60%, more preferably not less than 70%, better still not less than 80%, and most preferably not less than 90% by weight of benzyltoluene (BT), relative to the total weight of the formulation, and
an amount of less than 0.5 mol % of diphenylmethane (DPM), relative to the total number of moles of BT+DPM.

The formulation according to the present invention is a formulation that is liquid at ambient temperature and ambient pressure, i.e., at 25° C. and 1 atmosphere (1013 mbar or 1013 hPa).

As indicated earlier, the formulation according to the present invention comprises an amount of not less than 50% by weight of BT, preferably not less than 60%, more preferably not less than 70%, better still not less than 80%, and most preferably not less than 90% by weight of BT. In one especially preferred embodiment, the formulation according to the present invention comprises an amount of not less than 98% by weight of benzyltoluene (BT).

The formulation according to the present invention preferably comprises benzyltoluene alone, or optionally with one or more other LOHC fluids as indicated later on, in other words with no component other than DPM present in an amount of less than 0.5 mol %. Accordingly, and in one preferred embodiment, the formulation according to the invention comprises an amount of not more than 99.99% by weight of BT, preferably not more than 99.95% by weight of BT, more preferably not more than 99.9% by weight of BT.

As indicated earlier, the formulation may also comprise one or more other LOHC fluids well-known to those skilled in the art, such as those obtained from petroleum products and/or from products synthesized from petroleum products, or else obtained from renewable products and/or from products synthesized from renewable products. DPM is not considered to be an LOHC fluid of interest in the sense of the present invention.

Such other LOHC fluids are for example, and without limitation, those selected from dibenzyltoluene (DBT), diphenylethane (DPE), ditolyl ether (DT), phenylxylylethane (PXE), mono- and bixylylxylenes, 1,2,3,4-tetrahydro(1-phenylethyl)naphthalene, diisopropylnaphthalene, monoisopropylbiphenyl, phenylethylphenylethane (PEPE), N-ethylcarbazole, phenylpyridines, tolylpyridines, diphenylpyridines, dipyridylbenzenes, dipyridinetoluenes, and mixtures of two or more thereof, in any proportions, to state only the major known organic fluids that can be used in the context of the present invention.

According to one preferred embodiment of the present invention, the formulation comprises at least 50% by weight of benzyltoluene (BT), and of dibenzyltoluene (DBT). According to one embodiment of the present invention, the formulation comprises from 70% to 80% by weight of BT and from 20% to 30% by weight of DBT (relative to the total weight of BT+DBT). According to another embodiment, the formulation comprises from 80% to 99.9% by weight of BT and from 0.1% to 20% by weight of DBT (relative to the total weight of BT+DBT), the formulation preferably comprising from 90% to 99.9% by weight of BT and from 0.1% to 10% by weight of DBT (relative to the total weight of BT+DBT), and the formulation more preferably comprising from 90% to 99.5% by weight of BT and from 0.5% to 10% by weight of DBT (relative to the total weight of BT+DBT).

As indicated earlier, the formulation according to the present invention comprises an amount of less than 0.5 mol %, preferably not more than 0.4 mol %, advantageously not more than 0.3 mol %, more preferably not more than 0.1 mol % of DPM, relative to the total number of moles of BT+DPM. As indicated earlier, indeed, it has been established that the DPM very often causes many drawbacks, whether during the operations of hydrogenation/dehydrogenation to which the LOHC formulations are subjected, but also in the hydrogen released during operations of dehydrogenation, hydrogen that may then not have the degree of purity required for its intended applications.

The reason is that although formulations of LOHC fluids are especially well suited to transporting hydrogen in liquid form, and safely, these formulations must ensure that the hydrogen released during the dehydrogenation step has a purity at least as great as that of the hydrogen used to hydrogenate the support.

Hence the hydrogen transported using the formulation according to the present invention has a degree of purity entirely compatible particularly with applications such as, for example, fuel cells, and any other industrial applications requiring the use of high-purity hydrogen, such as the electronics sector for producing microprocessors, semiconductors, etc.

In one preferred embodiment of the present invention, the DPM is present in the formulation in an amount of between 1 molar ppm and 0.5 mol %, endpoints excluded, preferably more than 1 molar ppm and not more than 0.3 mol %, more preferably more than 1 molar ppm and not more than 0.1 mol %, relative to the total number of moles of BT+DPM.

Although not forming a preferred embodiment, the formulation according to the invention may further comprise one or more additives and/or fillers well-known to those skilled in the art and selected for example, and without limitation, from antioxidants, pigments, dyes, flavors, odor masking agents, viscosity modifiers, passivating agents, pour point depressants, decomposition inhibitors, and mixtures thereof.

The antioxidants that may advantageously be used in the formulation of the invention may include, as nonlimiting examples, phenolic antioxidants, such as, for example, dibutylhydroxytoluene, butylhydroxyanisole, tocopherols, and the acetates of these phenolic antioxidants. Further instances are the antioxidants of amine type, such as, for example, phenyl-α-naphthylamine, of diamine type, as for example N,N′-di(2-naphthyl)-para-phenylenediamine, but also ascorbic acid and its salts, esters of ascorbic acid, alone or as mixtures of two or more thereof or with other components, as for example green tea extracts and coffee extracts.

In one embodiment, the present invention relates to a formulation comprising:
an amount of not less than 50%, preferably not less than 60%, more preferably not less than 70%, better still not less than 80%, and most preferably not less than 90% by weight of benzyltoluene (BT), and
optionally at least one other LOHC fluid, other than the BT, preferably optionally at least one other LOHC fluid which is dibenzyltoluene (DBT),
an amount of between 1 molar ppm and 0.5 mol %, endpoints excluded, preferably more than 1 molar ppm and not more than 0.3 mol %, more preferably more than 1 molar ppm and not more than 0.1 mol %, relative to the total number of moles of BT+DPM,
optionally at least one additive, as defined earlier.

In another embodiment, the present invention relates to a formulation comprising:
an amount of not less than 50%, preferably not less than 60%, more preferably not less than 70%, better still not less than 80%, and most preferably not less than 90% by weight of benzyltoluene (BT), and
an amount of dibenzyltoluene (DBT) of between 0.1% and 30% by weight, relative to the total weight of the LOHC fluids present in said formulation,
an amount of between 1 molar ppm and 0.5 mol %, endpoints excluded, preferably more than 1 molar ppm and not more than 0.3 mol %, more preferably more than 1 molar ppm and not more than 0.1 mol %, relative to the total number of moles of BT+DPM,
optionally at least one additive and/or filler, as defined earlier.

Benzyltoluene (BT) is a well-known, commercially available compound whose method of preparation is likewise well-known to those skilled in the art. For example, BT is readily preparable by catalytic reaction of toluene with chlorotoluene, by techniques now well-known to those skilled in the art, and particularly as described in patent EP0435737.

The crude BT synthesis products, but also the BT-based LOHC fluids that have been engaged in hydrogenation/dehydrogenation cycles, may therefore contain variable amounts of DPM, as described earlier. The formulation according to the present invention may therefore be prepared, for example and typically, from these crude synthesis products or BT-based LOHC liquids, by any methods well-known to those skilled in the art.

Methods for preparing the formulation according to the present invention that may be contemplated and appear obvious to those skilled in the art are, for example, the distillation of a BT formulation to remove the DPM or at least to lower the DPM content of the BT. However, this solution suffers from numerous drawbacks, including the high costs and the complexities of the industrial plants implementing distillation steps (heating, application of vacuum or partial pressure, etc.), all the more so since the amounts of DPM for removal are often relatively small and the difference between the boiling points is relatively low (boiling point of BT=280° C., boiling point of DPM=264° C.).

Another possible method would be to start from a very high-purity toluene, particularly one free of or containing only minute traces of benzene, so as to minimize the formation of DPM. The cost of the “pure” BT formulation produced from this ultrapure toluene, however, would be entirely incompatible with an industrial-scale use.

According to one preferred embodiment, the formulation according to the present invention may advantageously be obtained from a crude BT synthesis product or from a crude BT distillation product or else from a BT-based formulation that has already undergone a greater or lesser number of hydrogenation/dehydrogenation cycles, by one or more treatments on filtering and/or adsorbing agents.

The filtering agents which can be used in the context of the present invention may be of any type and are well-known to those skilled in the art. The filtering agents which have proved to be the most suitable are adsorbent filtering agents, and more particularly filtering agents comprising one or more compounds chosen from minerals based on silicates, carbonates, coal, and also mixtures of two or more of these minerals in any proportions.

Nonlimiting examples include mineral or organic filtering agents, and particularly those selected from clays, zeolites, diatomaceous earths, ceramics, carbonates, and coal derivatives, and also mixtures of two or more thereof, in any proportions.

Mention may more particularly be made, as filtering, adsorbing, and filtering-adsorbing agents, of the following:
clays, including silicates, and for example magnesium silicates, such as, and without limitation, attapulgites, montmorillonites, selenites, bentonites, talcs, etc.,
natural or synthetic aluminum silicates, particularly kaolins, kaolinites, zeolites,
carbonates, for example calcium and/or magnesium carbonates, and more particularly those known under the names limestone or chalks,
derivatives of coal, wood, shells, for example coconut shells, olive pits or husks, and more generally those known under the name of activated carbons,
and others, and mixtures thereof.

Silicates, particularly clays and zeolites, have proven especially effective for preparing the formulation of the present invention. Silicates, indeed, have proven especially suitable for removing, or at least for substantially reducing, the amounts of DPM present in a formulation comprising an amount of not less than 50% by weight of benzyltoluene (BT).

According to one especially preferred embodiment of the present invention, examples of filtering agents that can be used advantageously for preparing the formulation of the present invention include the attapulgite Microsorb® 16/30 LVM from BASF (example of magnesium-aluminum clay with the chemical formula (Mg, Al)₅Si₈O₂₂(OH)₄, SiO₂), Amcol Rafinol 900 FF from Minerals Technologies, Amcol Rafinol 920 FF from Minerals Technologies, Amcol Mineral Bent (aluminum hydrosilicate) from Minerals Technologies, and Siliporite® products, in particular MK30B0 and MK30B2, from Arkema (preparations based on aluminosilicate zeolite).

In one especially preferred embodiment, the filtering agent used for preparing the formulation according to the present invention is selected from molecular sieves (also called “zeolitic adsorbents”), especially molecular sieves enabling the adsorption, as selectively as possible, of the DPM present in the formulation comprising at least 50% of BT.

The most appropriate zeolitic adsorbent materials, i.e. materials comprising one or more zeolites, are advantageously selected from molecular sieves based on synthetic zeolites which, by virtue of the wide variety of processes by which they are prepared, offer a great diversity of parameters that are amenable to fine adjustment, such as, for example, the thermal stability, the mechanical strength, or else the capacity for regeneration, in order to meet the specific criteria required for the envisaged use.

According to one preferred embodiment, the zeolitic adsorbent materials most suitable for use in the context of the present invention include natural or synthetic zeolites, and more particularly the zeolitic adsorbent materials selected from natural zeolites, as for example chabazite, and from synthetic zeolites, especially the zeolites of type LTA, the zeolites of type FAU, the zeolites of type EMT, the zeolites of type MFI, and the zeolites of type BEA.

These various types of zeolites are readily available to those skilled in the art commercially or are readily synthesizable by means of known procedures available in the scientific literature and in the patent literature. Moreover, the various types of zeolite are clearly defined and set out, for example, in the “Atlas of Zeolite Framework Types”, 5th edition, (2001), Elsevier.

The treatments on filtering and/or adsorbing agents that have just been described, and particularly the treatments on zeolites that have just been described, are effective and economical alternatives to the selection of an ultrapure toluene as starting material in the synthesis process, and even to expensive and complicated operations of distillation. Preparing the formulation according to the invention by treatment on a filtering and/or adsorbing agent, particularly on zeolite, has the great advantage that it tolerates a greater variety of starting materials at acceptable costs while enabling the provision of an end product (the BT) of very high purity. Furthermore, the use of filtering and/or adsorbing agents, particularly of zeolites, also enables the removal of some or all of one or more other impurities and unwanted compounds present inherently in the preparation of BT, or produced during the numerous cycles of hydrogenation/dehydrogenation of the formulation according to the present invention.

As an example, a BT formulation containing amounts of more than 0.5 mol % of DPM, typically 0.7, 0.8 and 0.9 mol %, is advantageously passed over a bed of zeolitic adsorbent, typically in the form of crystals of zeolite agglomerated with a binder, generally a clay. The zeolite crystals preferably comprise one or more cations, advantageously selected from cations of the alkali and alkaline earth metals, more specifically from lithium, sodium, potassium, magnesium, calcium, strontium and barium cations. Examples of zeolitic adsorbents include but are not limited to zeolitic adsorbents from the Siliporite® range sold by Arkema.

The treatment on a bed of zeolitic adsorbent may be performed at any temperature, advantageously at a temperature of between 5° C. and 80° C., typically around 40° C., and usually at atmospheric pressure, for obvious reasons of convenience of the process, with the proviso that the streams may be subjected to increased or reduced pressures in order to promote and/or facilitate the passage of the stream through the bed of adsorbent.

The treatment on zeolitic adsorbent described above in particular allows a lowering of the DPM content of a BT formulation to values of less than 0.20 mol %, better still less than 0.15 mol %, even better still less than 0.10 mol %.

According to another aspect, the present invention relates to the use of a formulation as defined above as LOHC fluid for producing hydrogen comprising a low level of impurities, and especially for producing hydrogen comprising an amount of less than 0.5 mol % of diphenylmethane, relative to the total number of moles of H₂+DPM.

By virtue of the formulation of the present invention, the hydrogen stored and then released during the dehydrogenation step is a high-purity hydrogen, and in particular a hydrogen containing only negligible amounts of benzene, or none. Hence the hydrogen thus produced may be used in a very large number of applications, especially for fuel cells, and all the other industrial applications requiring the use of high-purity hydrogen, such as the electronics sector for producing microprocessors, semiconductors, etc.

1-9. (canceled)

10. A liquid formulation comprising:
an amount of not less than 50%, by weight of benzyltoluene (BT), relative to the total weight of the formulation, and
an amount of less than 0.5 mol % of diphenylmethane (DPM), relative to the total number of moles of BT+DPM.

11. The formulation as claimed in claim 10, comprising an amount of not less than 98% by weight of benzyltoluene.

12. The formulation as claimed in claim 10, comprising one or more other LOHC fluids obtained from petroleum products and/or from products synthesized from petroleum products, or else obtained from renewable products and/or from products synthesized from renewable products.

13. The formulation as claimed in claim 10, comprising one or more other LOHC fluids selected from the group consisting of dibenzyltoluene, diphenylethane, ditolyl ether, phenylxylylethane, mono- and bixylylxylenes, 1,2,3,4-tetrahydro(1-phenylethyl)naphthalene, diisopropylnaphthalene, monoisopropylbiphenyl, phenylethylphenylethane, N-ethylcarbazole, phenylpyridines, tolylpyridines, diphenylpyridines, dipyridylbenzenes, dipyridinetoluenes, and mixtures of two or more thereof, in any proportions.

14. The formulation as claimed in claim 10, comprising at least 50% by weight of benzyltoluene and dibenzyltoluene, relative to the total weight of benzyltoluene and dibenzyltoluene.

15. The formulation as claimed in claim 10, comprising from 80% to 99.9% by weight of benzyltoluene and from 0.1% to 20% by weight of dibenzyltoluene (relative to the total weight of benzyltoluene and dibenzyltoluene).

16. The formulation as claimed in claim 10, comprising an amount of not more than 0.4 mol %, of DPM, relative to the total number of moles of BT+DPM.
